(19) United States
(12) Patent Application Publication
(10) Pub. No.: US 2015/0072183 A1
(43) Pub. Date: Mar. 12, 2015

(54) BATTERY CONTAINER COMPRISING A MEANS FOR NEUTRALISING HYDROFLUORIC ACID VAPOURS

(71) Applicant: RENAULT s.a.s., Boulogne Billancourt (FR)

(72) Inventors: Bruno Delobel, Issy Les Moulineaux (FR); Masato Origuchi, Rambouillet (FR)

(73) Assignee: RENAULT s.a.s., Boulogne Billancourt (FR)

(21) Appl. No.: 14/388,577

(22) PCT Filed: Mar. 26, 2013
(86) PCT No.: PCT/FR13/50643

§ 371 Date: Sep. 26, 2014

(30) Foreign Application Priority Data
Mar. 29, 2012 (FR) 1252821

(51) Int. Cl. H01M 10/52; H01M 2/12; H01M 10/052; H01M 2/02

(52) U.S. Cl. CPC H01M 10/52; H01M 2/0262; H01M 2/1223; H01M 10/052; H01M 2220/20
USPC 429/53; 429/176; 429/82

(57) ABSTRACT

A battery container comprising an outer casing surrounding a housing intended to receive at least one electric energy accumulator comprising Lithium hexafluorophosphate, the container comprising a filter comprising a silicon oxide-based material capable of filtering hydrofluoric acid vapours. The filter including an inner casing disposed between the outer casing and the housing of the container, the outer casing comprising an inner face against which the inner casing is secured, and the inner casing completely surrounds the housing.

The invention relates to a battery container intended for an electric vehicle.

An electric vehicle comprises a powerful battery. The battery comprises at least one electrical energy accumulator and a container containing the electrical energy accumulator. The accumulator is an electrochemical device for storing electricity. For example, a battery may comprise six identical electrical energy accumulators. The accumulators are electrically connected in series with one another by means of conductive bars.

Electrical energy accumulators are for the most part manufactured based on lithium hexafluorophosphate (LiPF₆). In case of accidental fire, which is highly unlikely considering the multiple safety devices implemented by the applicant, the combustion of the battery leads to the decomposition of the lithium hexafluorophosphate salt contained in the electrical energy accumulators, producing a release of hydrofluoric acid (HF). Specifically, the lithium hexafluorophosphate decomposes in the following manner:

LiPF₆+H₂O→LiF+H₃PO₄+5HF

Hydrofluoric acid vapors are harmful to humans and the environment.

Application DE 101 57 272 discloses a battery container comprising means for sorbing such vapors.

As a precautionary measure, the invention thus aims to reduce the emissions of hydrofluoric acid during an unlikely accidental combustion of the battery and more particularly of the electrical energy accumulators.

The invention relates to a battery container comprising an outer casing surrounding a housing intended to receive at least one electrical energy accumulator comprising lithium hexafluorophosphate (LiPF₆). The container has a filter comprising a material based on silicon oxide (SiO₂) capable of filtering hydrofluoric acid (HF) vapors, it being possible, for example, for these vapors to be emitted during the accidental combustion of the electrical energy accumulators.

According to the invention, the filter includes an inner casing positioned between the outer casing and the housing of the container, the outer casing comprising an inner face against which the inner casing is attached, the inner casing completely surrounds the housing.

Silicon oxide (SiO₂) is also referred to as silica.

The expression “a material based on silicon oxide” is understood to mean a material comprising silica that exists in the free state in various crystalline or amorphous forms or in the combined state in silicates, the SiO₂ groups then being bonded to other atoms (for example aluminum, iron, magnesium, calcium, sodium, potassium, etc.).

Silicates (or silicate materials) are silica-derived salts. The silicate used may be a tectosilicate or a phyllosilicate for example.

Thus, the invention makes it possible to reduce the emissions of hydrofluoric acid vapors emitted during the accidental combustion of a battery or more specifically of electrical energy accumulators based on lithium hexafluorophosphate salt.

The hydrofluoric acid vapors react chemically with the filter before they are released into the atmosphere. The filter forms a hydrofluoric acid vapor trap.

Tests show that an air flow with an initial concentration of 50 ppm of hydrofluoric acid has an HF concentration that is halved when this flow is filtered by glass wool.

The origin of the decrease in the HF concentration after filtration by the filter is explained partly by the adsorption of the hydrofluoric acid at the surface of the filter (the hydrofluoric acid and the silicate (or silica) materials have an affinity) and/or by a chemical reaction of hydrofluoric acid with silicon dioxide (SiO₂), known as silica, according to the following reaction:

SiO₂+6HF→H₂SiF₆+2H₂O

This reaction breaks down in the following manner:

SiO₂+4HF→SiF₄+2H₂O (1^{st} step)

3SiF₄+2H₂O→2H₂SiF₆+SiO₂ (2^{nd} step)

The silicon dioxide then behaves as a catalyst since it is found at the end of the reaction.

In various possible embodiments, the device of the invention may also be defined by the following features that could be considered individually or in any technically possible combination thereof and which each provide specific advantages:

The specific surface area of the filter material is at least 1 m²/g. When the filter material is in the form of foam for example, the latter filters the hydrofluoric acid vapors more when its specific surface area is high, of the order of 50 to 400 m²/g for example. The surface area that reacts with the hydrofluoric acid vapors is thus greater.

The filter material comprises calcium gluconate or calcium sulfate. When a glass foam is impregnated with a salt that is active with respect to hydrofluoric acid, the filtering power of the filter material increases.

In one preferred embodiment, the inner face of the outer casing may be entirely covered by the inner casing of the filter, which may in addition be at least partially formed by a fibrous material, especially glass wool that includes silicon oxide.

In this embodiment, the filter has two functions since it may also be used as thermal insulation in the battery pack. The glass wool, for example, is used as thermal insulation and as a filter for hydrofluoric acid vapors in the event of combustion of the battery.

According to another possible embodiment, the battery container comprises at least one fume-discharging device equipped with an orifice that enables a fluidic communication between the inside and the outside of the container. The filter is positioned in the orifice.

The filter may be self-supported, which limits the number of parts.

According to another possible embodiment, the fume-discharging device comprises at least one metal grid positioned inside the orifice in order to support the filter.

A valve may be associated with the orifice (or each orifice) enabling the opening and/or closing of the latter.

The filter is positioned upstream of the valve.

The invention will be better described by the figures below:

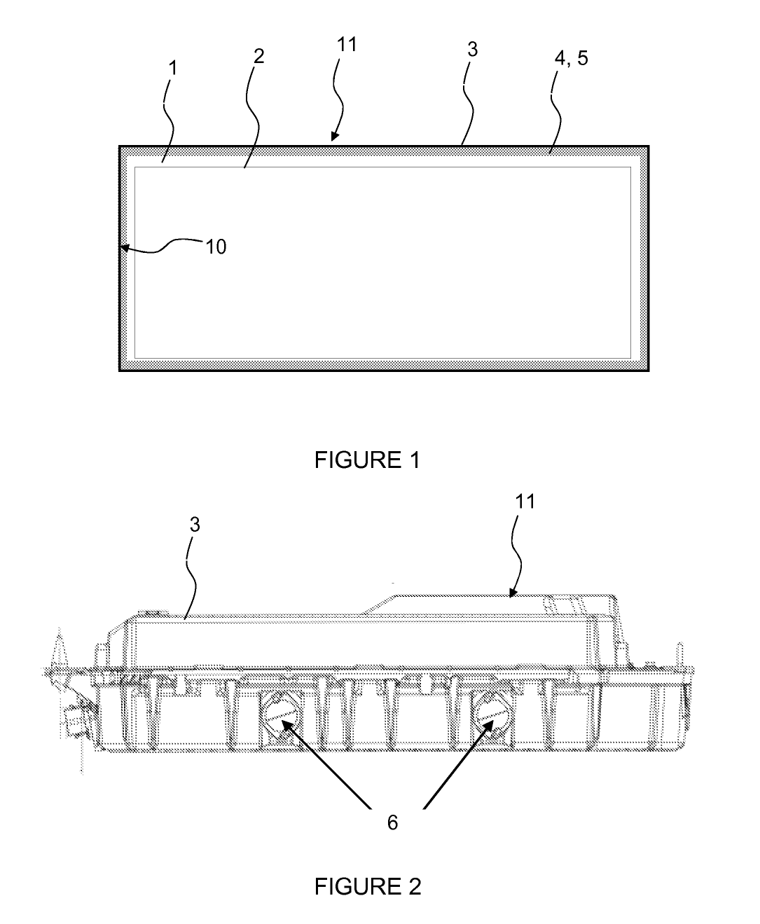

FIG. 1 schematically represents a battery comprising a filter formed by an inner casing covering the outer casing of the container, according to a first embodiment of the invention;

FIG. 2 schematically represents a battery comprising two fume-discharging devices, each equipped with a filter, according to a second embodiment of the invention;

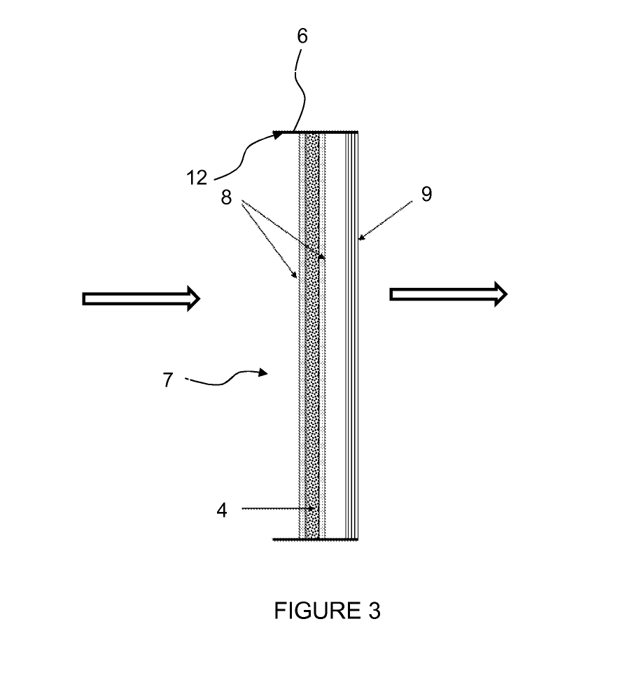

FIG. 3 schematically represents the orifice of the fume-discharging device equipped with a filter.

FIG. 1 schematically represents a battery comprising a battery container 11 comprising an outer casing 3 surrounding a housing 1 intended to receive at least one electrical energy accumulator 2 comprising lithium hexafluorophosphate (LiPF₆). The battery container 11 may be made of polymer or made of metal and is used to protect the electrical energy accumulators 2 from external impacts.

The battery container 11 has a filter 4 that comprises a material based on silicon oxide (SiO₂) (or silica) that filters hydrofluoric acid (HF) vapors emitted during the accidental combustion of the battery 2.

The expression “a material based on silicon oxide” is understood to mean a material formed with silica that exists in the free state in various crystalline or amorphous forms or in the combined state in silicates, the SiO₂ groups then being bonded to other atoms (for example aluminum, iron, magnesium, calcium, sodium, potassium, etc.).

Silicates (or silicate materials) are silica-derived salts. The silicate used may be a tectosilicate or a phyllosilicate for example.

The specific surface area of the filter material is at least 1 m²/g. When the filter material is in the form of foam for example, the latter filters the hydrofluoric acid vapors more when its specific surface area is high (50-400 m²/g). The surface area that reacts with the hydrofluoric acid vapors is thus greater.

As a variant, the filter material may comprise calcium gluconate or calcium sulfate. The advantage of these two calcium salts is their reactivity with fluorine: Ca⁺² reacts with 2F⁻ to give CaF₂. When a glass foam is impregnated with a salt that is active with respect to hydrofluoric acid, the filtering power of the filter material increases.

The filter material may be in various forms such as glass wool, a foam, or fibers with a generic chemical composition a (SiO₂)-b(MgO)-c(CaO)-d(Al₂O₃)-e(ZrO₂)-f(Na₂CO₃) , with a, b, c, d, e and f being the fractions of the various components of the glass such that a+b+c+d+e+f=1, 0<a<1, 0<b<0.5, 0<c<0.5, 0<d<1 and 0<e<0.2.

According to a first embodiment represented in FIG. 1, the filter 4 includes an inner casing 5 positioned inside the container and more specifically between the outer casing 3 and the housing 1 of the container.

Its thickness is at least 1 mm.

Preferably, the outer casing 3 comprises an inner face 10 against which the inner casing 5 is attached. The inner casing 5 may entirely cover the outer casing 3. The inner casing 5 completely surrounds the housing 1.

In this case, the filter 4 has two functions since it may also be used as thermal insulation in the battery pack. If the filter 4 is made of glass wool, for example, it is used as thermal insulation and to filter the hydrofluoric acid vapors in the event of accidental combustion of the battery pack.

Other layers or casings may be provided between the outer casing 3 and the inner casing 5 formed by the filter 4.

When the electrical energy accumulators 2 are burning a portion of the hydrofluoric acid vapors are trapped by the filter 4.

The fact that the filter 4 surrounds the electrical energy accumulators 2 enables it to extend over a large surface area and to trap a large amount of hydrofluoric acid vapors.

According to a second possible embodiment represented in FIG. 2, the battery container 11 comprises at least one fume-discharging device 6 equipped with an orifice 7 that enables a fluidic communication between the inside and the outside of the container, and that receives the filter 4. As illustrated in FIG. 2, the battery container 11 comprises two fume-discharging devices 6. As illustrated in FIG. 3, the filter 4 is positioned inside the orifice 7. It has a size adapted to completely fill the orifice 7. The contour of the filter 4 matches the shape of the orifice 7. In FIG. 3, the filter 4 is in the form of a circular pellet. It may have an oval shape or other shape. The filter 4 may be made of glass wool, of foam, of fiberglass or something else. The arrows from FIG. 3 represent the flow direction of the gases.

The filter 4 may be self-supported, which limits the number of parts in the orifice. Its thickness and its rigidity are sufficient so that it can hold itself up without support means in the orifice. The filter is then clamped by the inner peripheral wall 12 delimiting the orifice 7 of the fume-discharging device 6.

According to another possible embodiment, the fume-discharging device 6 comprises at least one metal grid 8 positioned inside the orifice 7 in order to support the filter 4.

Preferably, the fume-discharging device 6 comprises two metal grids 8 positioned inside the orifice 7 in order to support the filter 4, as represented in FIG. 3. The filter 4 is formed by glass wool. The metal grids 8 are positioned on each side of the filter and are in contact with the latter. They are substantially parallel to the filter and perpendicular to the central axis of the orifice. The metal grids 8 enable mechanical support of the filter while allowing the gases to pass through.

The fume-discharging device 6 comprises a valve 9 associated with each orifice 7 enabling the opening or closing of the latter. The filter 4 is positioned upstream of the valve 9 with respect to the flow direction of the hydrofluoric acid vapors, and more specifically at the inlet of the orifice 7. The valve 9 is positioned at the outlet of the orifice 7. It opens when the pressure of the gases inside the container is greater than atmospheric pressure, making it possible to discharge fumes in the event of accidental combustion of the accumulator. When the hydrofluoric acid-loaded fumes pass into the orifice, a portion of the hydrofluoric acid vapors is filtered by the filter 4.

In FIG. 2, the fume-discharging devices 6 are positioned on the side walls of the container. They may be positioned differently, for instance on the upper wall of the container. The diameter of the orifices and of the filter in pellet form is at least 4 cm. The thickness of the filter is at least 1 cm. Preferably, a space is provided between the valve and the filter. It is at least 5 mm.

The advantage of the filter 4 according to the invention is that it is possible to use the filter material in several forms (internal casing or pellet for example).

1. A battery container comprising an outer casing surrounding a housing intended to receive at least one electrical energy accumulator comprising lithium hexafluorophosphate, the container having a filter comprising a material based on silicon oxide capable of filtering hydrofluoric acid vapors, the container being characterized in that, the filter including an inner casing positioned between the outer casing and the housing of the container, the outer casing comprising an inner face against which the inner casing is attached, the inner casing completely surrounds the housing.

2. The battery container as claimed in claim 1, characterized in that the inner face of the outer casing is entirely covered by the inner casing of the filter.

3. The battery container as claimed in claim 2, characterized in that the filter is at least partially formed by a fibrous material, especially glass wool that includes silicon oxide.

4. The battery container as claimed in claim 1, characterized in that it comprises at least one fume-discharging device equipped with an orifice that enables a fluidic communication between the inside and the outside of the container, the filter being positioned in the orifice.

5. The battery container as claimed in claim 4, characterized in that the filter is self-supported.

6. The battery container as claimed in claim 4, characterized in that the fume-discharging device comprises at least one metal grid positioned inside the orifice in order to support the filter.

7. The battery container as claimed in claim 1, characterized in that a valve is provided at the outlet of the orifice in order to open or close the latter, the filter being positioned upstream of the valve with respect to the flow direction of the hydrofluoric acid vapors.

8. The battery container as claimed in claim 1, characterized in that the specific surface area of the filter material is at least 1 m²/g.

9. The battery container as claimed in claim 1, characterized in that the filter material comprises calcium gluconate or calcium sulfate.
